(19) United States
(12) Patent Application Publication
(10) Pub. No.: US 2006/0282399 A1
(43) Pub. Date: Dec. 14, 2006

(54) Digital sound recording personalized at a time and place remote from initial delivery to a retail customer

(76) Inventors: Richard Ackermann, Carlsbad, CA (US); Kurt Penberg, Carlsbad, CA (US)

Correspondence Address: William C. Fuess, Suite 2G, 109951 Sorrento Valley Road, San Diego, CA, 92121-1613, US

(21) Appl. No.: 11/418,660

(22) Filed: May 5, 2006

Related U.S. Application Data
(63) Continuation-in-part of application No. 11/125,658, filed on May 9, 2005.

(51) Int. Cl. G06F 17/00

(52) U.S. Cl. 705/500

(57) ABSTRACT

A retail customer is sold and delivered a digital medium in which is contained personalizable content of interest to children but no personalization, and also a personalization computer program executable in receipt of some particular name so as to modify the digital medium to, upon subsequent use of its content, invoke a particular name, therein serving to personalize this subsequent use of the content of the digital medium to the particular name. The retail customer or a consumer subsequently executes, normally at a place and a time remote from purchase and delivery, and on a computer in which is present both the digital medium and the delivered computer program, the computer program in respect of a particular child's name that is both selected and entered into the computer and into its executing program by the retail customer or consumer. The digital medium is thereby personalized, making it so that all subsequent use of its content will invoke the particular selected and entered name.

### RELATED APPLICATIONS

The present invention is a continuation-in-part of U.S. patent application Ser. No. 11/125,685 filed May 9, 2005 titled “CHILDREN'S MUSIC, STORY AND/OR INTERACTIVE CDS/DVDS PERSONALIZED TO A CHILD'S NAME AT A TIME AND PLACE REMOTE FROM INITIAL DELIVERY TO A CUSTOMER.” The contents of U.S. patent application Ser. No. 11/125,685 are incorporated herein by reference. U.S. patent application Ser. No. 11/125,685 is referred to herein as the “Parent Patent Application.”

### BACKGROUND OF THE INVENTION

The present invention generally relates to personalized sound recordings such as children's music, story and/or activity books and audio-visual recordings that are both delivered on digital media, such as compact disks of the CD and DVD type (circa 2005), and that are personalized with, inter alia, the child's name.

The present invention specifically relates to improvements in the time, place and manner of the personalization of a sound recording provided in a digital medium such as a CD or DVD.

Reasons, circa 2005, of the Personalization of Stories, Activities Including Coloring Books and Games, Music and/or Video Primarily Intended for Children

It has long been known by parents that children respond strongly to their own name as part of their formation of self-awareness, self-identity, and individual personality. In the modern, digital, age new personalized products for children, starting with simple storybooks, have, by their commercial and application successes, not only confirmed parental expectations that a child responds better to a more personalized learning and play environment, but that the children themselves both like this environment and mature better in it. Indeed, there is scarcely anything negative that can be said about a well-structured educational and acculturation process that, even if not targeted on the requirements of a individual child due to lack of teacher or parental resource, is at least sufficiently personalized to an individual child, particularly by frequent inclusion of the child's name so as to appear each of relevant, friendly and intimate to the child.

That something that is, as of present, so simple as the personalization of children's learning and play materials should produce such unalloyed good results demands a wider usage of this technique. It may be that modem media ranging from monitors displaying print to sound to video is, as based on digital technology, remote from the “natural world”, and that personalization helps children, in particular, to overcome the innate “strangeness” of the modern, first-world, structured learning and play experiences. Or it may be that machines including computers are cold and distant enough already, and that personalization makes them more compatible with humans, as presently demonstrated with the imparting of “personality” to robots at the MIT Media Laboratory. Or it may be that humans of all ages merely like to hear the sound of their own name, and are, especially as children, more comfortable in harboring the delusion that a machine-rendered media experience is unique to themselves, only.

General State, Circa 2005, of the Personalization of Stories, Activities Including Coloring Books and Games, Music and/or Video Primarily Intended for Children

Over the course of the past ten years increasing numbers of different types of subject matter as is contained in digital media has been personalized for children. Beyond the basic affixation of book labels denoting ownership to books, the first personalization of media for children involved only the text of digitized storybooks. Placement of custom information such as a particular child's name within the digital texts was analogous to the “mail merge” capabilities of contemporaneous word processing programs. Over the course of years, stories have now become personalized in quite sophisticated manners, where any of the child's parents, geographical location, named friends, gender, favorite hobbies and activities, and like information concerning a particular child are “blended in” to a stock story in order to personalize the story for the child.

Personalization of music, or songs, graphics, and also activity books, transpired next. Music personalization is typically carried out using generally short clips on which recording artists sing the name of a particular child, and digitally merging a selected one or more into longer musical works. Graphics may selectively be included relevant to the presented story. The story itself can increasingly be personalized to a particular child. Activity books personalize a range of activities for a particular child, by, for example, stressing by more frequent inclusion, any activities such as coloring, solving puzzles, and so forth, that are indicated as being preferred by a particular child, and/or suitable to the age and development of the particular child.

Personalization of video is expected next. As an example, a cartoon-like character bearing a particular selected child's name, and similar in general appearance to the particular child will probably first appear in video vignettes, followed by longer and more highly personalized presentations as technology permits.

Problems and Limitations, Circa 2005, of the Personalization of Stories, Activities Including Coloring Books and Games, Music and/or Video Primarily Intended for Children

Personalized digital materials for children are, by definition, created on a person-by-person basis.

Even in the case of simple personalized print text, which text may or may not be accompanied by graphics, such graphics themselves possibly being personalized, the generation of media containing the text has historically been centralized at the point(s) of providing the medium to the retail customer, e.g., the point(s) of sale. That is, the personalized books are centrally made by a manufacturer, who may take orders therefor online, e.g., on a Website or else through agents or dealers, or are made with computers and printers by broker-dealers who are commonly franchisees, and licensees, of each of technology and/or creation methods, custom computer software programs performing the customization, and copyrighted content. As an example, book blanks and software containing personalizable text may be provided to a kiosk. At the Kiosk, a retail customer provides the name and/or other personal data about the child, and a personalized book is printed by performing a merge of personal information with a stock story of personalizable text.

Note that by the term “retail customer” used throughout this document, is meant the final purchaser or a consumer of the digital medium. This may be, for example, the parent or uncle of a child for whom, and with whose name and other particulars the medium is to be personalized. Note also that the “retail customer” need not always be the actual final purchaser. For example, an uncle may purchase a gift for a parent that includes a digital medium containing personalizable content. The parent receives the gift and may then do the actual personalization. Or the parent may give the received gift to another family member to do the actual personalization.

Even though a computer literate consumer or retail customer, e.g., parent having only word processing skills and minimal equipments can create, and print, a personalized child's story, the supply of these useful documents has been nearly exclusive commercial, and centralized to point of sale. See the section above providing the general state, circa 2005, of the personalization of stories, activities including coloring books and games, music and/or video primarily intended for children. There are at least four possible reasons that personalizing has been only commercial. First, the personalized story or stories are best bound, e.g., bound together into a book, a storybook. For best appearance and maximum durability of the storybook product given the child, this requires bookbinding equipments not normally possessed by parents or other non-commercial parties. Second, the retail customer, e.g., the parent or other amateur party producing the personalization may not have the necessary computer expertise, and even specialty programs directed to this purpose may present such a steep learning curve as would make the project ill advised for the personalization of but a few works for a few different children. Third, the retail customer, e.g., the parent or other amateur party producing the personalization may not have access to, nor reproduction rights in, literary materials, e.g., stories, and characters, that are of topical interest to the child. Fourth, the retail customer, e.g., the parent or other amateur party producing the personalization may not have access to quality color imaging and printing equipments for the rendering of graphics accompanying the story. Even if equipment like color laser printers is used, they often do not conveniently carry out duplex printing to both sides of a sheet. Furthermore, costs are high and quality low relative to mass-printed pages.

Therefore, most personalized storybooks are commercially created by the printing of some or all text, and only but some of the graphics, with permissible text overlays on these and pre-existing graphics, so as to create a personalized storybook. The cumulative pages are then typically assembled inside a cover, which may itself be pre-printed, pre-printed-in-part, and/or custom-printed.

Requirements for centralized production are even more acute for personalization of music, or songs. Computer software for personalizing of digital music by the melding of musical clips is normally proprietary, specific to the task at hand, and/or not suitably provided, even by licensing, to parties who may not be trustworthy in its protection and use. Second, the musical works, or songs, are normally proprietary. Moreover, the databases of musical “clips” which are inserted within the musical work so as to personalize it to a particular child are extensive, expensive, and/or proprietary. Third, the computer and computer equipments necessary to reliably write a proper CD, or DVD, are generally equally or more expensive than is a color printer—which may still be required for the album cover, harder to operate, and harder to transport, e.g., to a point of sale in a shopping mall.

The challenges to be expected in the personalization of video are even greater.

Aspects of the present invention provide for efficient and effective “in-home” personalization of a digital medium by the retail customer. The digital medium contains personalizable content, e.g., one or more personalizable stories, personalizable activities, and/or personalizable music. In the future, the medium also will contain personalizable video, and aspects of the present invention are intended to cover this feature. In one version, the digital medium prior to personalization, normally a CD or DVD is still both useful and usable until personalized. Personalization is a one-item activity carried out by the retail customer. The bottleneck and delay of personalization at a point of sale are thus avoided. According to another aspect, the proprietary nature of the personalization software of the manufacture, including the database of clips, are still protected, e.g., provided in encrypted form.

Specific Prior Art

Although the digital medium personalization system of present invention is believed to be substantially dissimilar from anything heretofore existing or contemplated, certain specific prior art is discussed in the following sections as general background of personalized digital medium product, and the industry presently (circa 2005) making these products. For purposes of coherent, the art is grouped by company within the personalization industry.

Create-A-Book

An early, and persisting, business for the creation and sale of personalized children's books is Create-A-Book, 1478 College Parkway, Gulf Breeze, Fla. 32563.

Operator of the business, Mr. Hefty, has several United States Patents, including U.S. Pat. No. 5,114,291 for a method of making personalized children's storybooks. This method generally pertains to the making of a book, and more particularly pertains to the making of a personalized children's storybook using a computer to form text pages having pre-stored, non-variable text merged with personalized, variable text to create an individualized story line. The method of the U.S. Pat. No. 5,114,291 invention utilizes a personal computer and a laser printer to make text pages for a personalized children's storybook. The text pages include non-variable text and variable text. The non-variable text comprises general information which does not change or vary from book to book of the same title. The variable text comprises specific information which changes or varies for each book depending on the recipient of the book.

Mr. Hefty also has U.S. Pat. Nos. 5,190,316, 5,454,678 and 5,636,957, all concerning aspects of a method of making personalized children's storybook utilizing stickers wherein a personalized children's storybook is made using preprinted books and inserting stickers containing personalized, variable text to create an individualized story line.

Mr. Hefty further has U.S. Pat. No. 5,915,904 for a binding device used for crimping or deforming a U-shaped channel around a plurality of sheets of paper comprises a stationary crimping bar and a rotatable crimping bar rotatable coupled above the stationary crimping bar. This binding device is perceived to be useful in the creation of personalized children's books.

Best Personalized Books

Another U.S. business that is, circa 2005, delivering personalized products for children is Best Personalized Books, Best Plaza, 4201 Airborn Drive, Addison, Tex. 75001. Best Personalized Books sells, as well as personalized children's books, products called Best Personalized Cards, Names Expressions™, Invitation Stationery, Personalized Clocks, Creative Expressions, Family Name Origins, Birthday Chronicle. Pet Pedigree, and Birthday Chronicle.

This business is the assignee of U.S. Pat. No. 5,213,461 to Kalisher for a method for rapidly generating personalized books while a retail customer waits. This patented method relates generally to the creation of books or documents and, more particularly, to a process for rapidly generating personalized books while a retail customer waits. In carrying out the method of the U.S. Pat. No. 5,213,461 invention, a series of steps is performed that includes loading a program having a predetermined story stored therein into a computer, entering personalized data into the computer to create a personalized story therefrom, feeding into a printing device a set of sheets having a first and second side, printing the personalized story on one of the sides of the sheets, separating the sheets transversely into pages, assembling the pages in a predetermined order and the fastening the assembled pages to a book jacket to form a personalized book. The sheets used in the disclosed method are, in one embodiment, standard size, coated paper and have a partially preprinted design or illustration that partially covers the top side of each sheet, leaving blank areas for the story text, and fully covers the bottom side of the sheets.

Best Personalized Books is the further assignee of U.S. Pat. No. 5,524,932 to Kalisher for sticker-based methods of making a personalized children's storybook. These patented methods concern the making a personalized children's storybook using preprinted books with textually blank areas on various ones of their pages, and adhering transparent stickers with personalized text thereon to the textually blank page areas to create a personalized story line in the book.

Best Personalized Books is the further assignee of U.S. Pat. No. 6,174,120 to Kalisher for an apparatus for affixing book pages to a book cover and process for making same. This patented apparatus and method concerns affixing book pages to a book cover by use of a sheet of paper with at least one waxy side and two stickers, each having a first side, the first side being sticky and removably affixed to the waxy side of the sheet of paper. In one embodiment of the U.S. Pat. No. 6,174,120 invention, the two stickers are separated by a distance to accommodate the thickness of pages of a book. The apparatus also has a means for easy removal of the stickers from said sheet and is, in one embodiment, done by having the sheet of paper extending beyond each of the stickers to allow for easy separation of the stickers from the sheet of paper. The stickers may be attached to the book pages by a variety of means such as staples, channel binding, or otherwise. The U.S. Pat. No. 6,174,120 method includes the steps of aligning one or more stickers removably attached to a sheet of paper with pages of a book, affixing the stickers to the book pages, removing at least part of the sheet of paper from the sticker, and attaching the sticker to an inside cover of a book. One U.S. Pat. No. 6,174,120 embodiment includes affixing the stickers to the book pages by stapling, U-shaped channel binding, or otherwise.

Created 4 Me

Yet another business providing personalized children's books circa 2005 is Created 4 Me, P.O. Box 11360, Boulder, Colo. 80301. Once an order is received, including through a Website, Created 4 me creates a book around the specific name that the retail customer provides.

Created 4 Me alleges to uniquely personalize a book with the provided child's name, making the child the “star of the show” in a product called “My Name in Lights.” In this product children are allegedly treated to a whimsical theatrical performance where their name is spelled out by delightful alphabet characters. Each 8½″×11″ apparently professionally-bound hardcover book is unique and is created around a child's first, middle and last name. The last page of each My Name in Lights book includes the entire whimsical Cast of Characters alphabet. Also included is a dedication page where the retail customer has the option of including the child's birth date and a special message. Any name can be accommodated, whether it's Ashley Madison Smith or Cameron Jacob Grant Phillips.

One-of-a-kind books are created featuring the letters from a child's first, middle and last names. No two are alike. Alphabet characters spell out the name and help children learn simple words that begin with each letter. My Name in Lights is sold as a personalized gift for baby, birthday or holiday. It's claimed that children learn from and treasure such a gift as a keepsake because it was created for them with love.

MYCD Story

MYCD Incorporated, 245 Park Avenue, 39th Floor, New York, N.Y. 10167, produces, circa 2005, a range of personalized interactive story books on CD-ROM for playback on a personal computer (PC) where a particular named child becomes the Star of the adventure.

MYCD claimed that their stories uniquely “grow with the child”. Giving three levels of story, each CD develops the learning ability of the child and is packed with interactive fun and animation.

Each CD story book contains the child's full name, age, home-town, two friends names, an adult, a two-line dedication and the name of the giver, making this a truly personalized product. The child's full name is in accordance with any spelling chosen, and is not limited by a database. The child's age and hometown are featured. Two named friends appear, building the friendship aspect of the story. An adult also appears in the story, promoting child safety. According to all details that appear throughout the story, the book becomes a truly personal adventure the child.

CDs also feature a welcome screen showing a personal message from the giver, including their name.

Each story has fully interactive animated pages.

There are three difficulty levels to each story, allowing the story to grow with the child.

Also extra educational puzzles and games promote fun and learning.

The MYCD business is franchised to be run from a franchisee's home or operated in a retail environment, and is stated to be ideal for both full and part time options. The franchisee requires both a PC and a CD writer, which, if so chosen, can be transported to a retail site allowing the creation and sale instant personalized gifts for retail customers in just a few minutes. It takes only 2 minutes to make an Interactive CD.

The “while you wait” concept is claimed to provide a number of retailing opportunities, as well as numerous home based opportunities to explore. The business is advanced as being flexible, where a retailer or franchisee can choose the marketing options that suit you best. Most people base their business at home, where overheads are minimized. There is always the possibility to take up a retail concession or site towards Christmas in order to maximize sales at this busy time of year.

It should be noted that MYCD STORY creates a non-audio story that has text about a child, but no personalized graphics and no audio. The resulting CD-ROM is for use on a computer, not, for example, on a CD-player.

Children Juke Box

Children Juke Box, 5135 Avenida Encinas, Suite B, Carlsbad, Calif. 92008 furnishes a collection of personalized music for children, e.g., in the form of audio CDs playable, for example, on a CD player. Personalized Music for children is claimed to make the ultimate gift that a child will love to listen to over and over again. Children Juke Box has gathered a collection of music claimed to comprise the widest selection of personalized CDs and names available.

Children Juke Box CD's are stated to help a child feel loved and special. A child hears his or her name over and over again in a children's music CD. Each CD is compiled of 6 to 10 entertaining songs that mention the child's name at least 40 times.

The child is claimed to build name recognition and self-esteem thru the upbeat music. From waking up in the morning right down to to a bedtime lullaby, each song captures the child's attention and imagination. Everyone in the family can enjoy and even dance to the music.

Elmo He Knows My Name

Fisher-Price, Inc. a Division of Mattel, Inc. of East Aurora, N.Y., makes a plush toy called Elmo He Knows My Name Circa early 2005, a retail customer purchases the toy, e.g., at a retail outlet such as Toys-R-Us, and the retailer uses as apparatus to personalize the toy prior to the retail customer taking the toy home. The toy has limited audio capabilities, and speaks simple phrases using the provided name, e.g., of a child.

Children Story Book

Children Story Book LLC, 5135 Avenida Encinas, Suite B, Carlsbad, Calif. 92008, the assignee of the present invention, makes personalized, interactive, animated, audio CD story books for children. These CDs are playable on a home computer such as a PC. It is represented that unlike any other personalized story book, a Children Story Book automatically reads the story to your child, and that a Children Story Book offers a greater level of personalization than any other product.

When a Children Story Book CD is ordered the retail customer chooses the child's name, race, gender, hair color, and eye color. Even parents who appear in the stories are also personalized. With a Children Story Book the retail customer is stated to be provided with a truly personalized and exciting product that draws your child into the story and makes him or her the star of the show.

The vividly illustrated and animated scenes are claimed to be fun and interactive to an uncommon degree. Children Story Book is alleged to keep a child reading and clicking with the kind of interest that can only be admired. Mere personalized paper books are stated not to compare favorably with Children Story Book animation and personalization that “leaps off the page”.

Every Children Story Book CD is an original story about a subject that is exciting for children. The stories are written for children aged 3-7. Each story has 15 or more vividly illustrated scenes with interactive animation and a maze to boot.

After the child hears the scene read to him or her, the child clicks on objects in the scene that either speak or move, and make sounds. This interaction draws the child further into the story and makes him or her feel part of the story, all the more so because the story is personalized with the child's name and personalized with the child's gender, race, hair color and eye color.

The child is also able to click and make the narration repeat itself, or move to the next scene at the child's own pace. Every scene in the story has an icon to turn the narration on or off, allowing the child to read to himself or herself. Every scene also has a vocabulary icon that turns on the visual dictionary when the mouse glides over an object.

A Children Story Book is stated to be the only fully personalized interactive audio Story Book CD on the market. The computer reads the story to the child. The story enhances reading skills and includes vocabulary builder. The story is personalized for gender, race, hair color, and eye color.

More than 2,000 boy and girl names are available circa 2005 and the list is growing. It is stated that if Children Story Book does not have the name wanted, the retail customer should simply send the name needed. Periodically hundreds of new names are released based upon requests. This includes all names, all the time, regardless of how unusual they may be.

Each child can read at his or her own pace. Animation and interactive means fun. Every scene of every story can be printed for coloring. Every Story Book CD comes with a maze game with three levels. Stories are alleged to appeal to adults as well as children.

The Children Story Books are stated to be the only Story Book CDs in the world that are personalized with your child's name and that further permit the retail customer to choose race, gender, hair color, and eye color. These chosen parameters are claimed to offer the most realistic and complete personalization experience possible. Making it so that the child will literally see himself or herself as the star of the story.

At least some sales by Children Story Book are presently, circa 2005, through distributors of the CDs. Goods are offered at wholesale to distributors, who have a Children Juke Box system distributor system. The Children Juke Box system distributor system permits a distributor to create personalized CDs in under 2 minutes. A labeling program permits a distributor to personalize the spelling of the name and add a personalized message, e.g., “To Julie with all our love, Mommy and Daddy.”

In summary, Children Juke Box products are claimed to “open the door for the happiness of children everywhere when they hear the beauty of personalized music for children”.

Motivation for the Present Invention

Historically, CD storybooks and personalized music CDs have been sold at a location such as a kiosk equipped with a computer and CD burner. A retail customer requests a story title for a particular child and gives the child's name, race, skin color, eye color, hair color and gender. All of these attributes are applied dynamically to the lead character in the animated and interactive story. The burn software application assembles these attributes along with the rest of the story artwork, sound files, and framework in order produce a custom personalized story for the child. The story is burned onto a CD and given to the retail customer. This whole process is performed by an attendant at the kiosk who enters the retail customer's information into the Story Book burn software.

The disadvantage of this model is that it requires a computer with a CD burner and an attendant to operate the software. It works great for kiosks, but many stores employ personnel that do not have the skill needed to operate such a system. Furthermore, a sale of a wrapped retail CD is much simpler than personalizing a CD.

Thus, there is a need in the art for a method that includes providing to a retail customer a digital medium that includes personalizable content. Producing a personalized digital medium such as a personalized CD storybook and/or a personalized music CD includes personalizing the provided digital medium with the personalizable content medium on demand and at a location of a retail customer's choosing, e.g., by the retail customer.

### SUMMARY OF THE INVENTION

Aspects for the present invention contemplate improvements in time, place and manner by which personalizable content such as digitized music CDs and stories sold for use, typically, for a child are personalized by a retail customer or consumer with, inter alia, the name of the child so that the personalized content subsequently played back to or by the child contains personalized references to the child, including the name of the child.

Specifically, aspects of the present invention contemplate personalization of personalizable content such as digitized children's music and/or children's stories, as are typically sold on digital media such as CDs and/or DVDs, at each of a time and a place that is permissively remote from the time and location of sale, and from the time and location of initial delivery of the digital media to the retail customer. One aspect includes the ultimate personalization being by a semi-automated method that specifically does not require any involvement by the seller at the time(s) or the location(s) of sale or delivery. While the seller is no longer involved in personalization of the content, e.g., the children's music of children's stories to a particular, named, child—the seller simply sells ubiquitous and universal digital media containing musical and literary works—the impact of these products on a particular child can nevertheless be enhanced by a subsequent personalization with, among other possibilities, the child's own name.

Furthermore, aspects of the present invention contemplate that personalizable content digitized children's music and digitized children's stories can be sold on digital media, normally CDs and DVDs, in accompaniment with personalization software and personalization data, or with links to one or more locations on the Internet containing one or both of personalization software and personalization data.

One embodiment of the personalization software is exceedingly modest in scope, and is normally co-located upon the same digital medium as the personalizable content. In one alternative, the software may be downloaded and installed from one or more locations, e.g., a manufacturer's site(s) on the Internet. The personalization software, from wherever obtained, in one embodiment executes automatically upon the digital medium being inserted into a CD/DVD reader on a personal computer. The software executes until personalization of personalizable content on the digital medium to a particular child completes. In one embodiment, thereafter, the software, which may still be present on the digital medium, is not normally executed again, and in particular, is not automatically executed again, and in one embodiment, indeed, will do nothing if attempted to be executed on a digital medium whose content that has already been personalized.

According to one implementation, the personalization data is on the same digital medium as the personalizable content. In an alternate implementation, the personalization data is on one or more companion media, such as at least one companion CD or DVD. In another alternate implementation, the personalization data is on a remote server accessible via the Internet. The remote storage location is typical, because of the voluminous nature of the cumulative personalization data relevant to all children's names and/or other circumstances, combined. Other options may be provided for retail customers who may have no access to the Internet.

In the case personalization data is on a remote server, a remote computer, e.g., the retail customer's or another consumer's computer runs the personalization program. Such a program includes providing to the server information on what individual-type music and/or story content is on the medium and is being personalized—out of many different such possible content types. In one embodiment, the personalization program is executed in response to questions and information provided on the subject, e.g., on the child, including the child's name. In one implementation, a computer program running remotely on the server assembles particular data relevant to personalizing the individual-type media for this particular child from data pertinent to literally thousands of different children's names—or in some embodiments builds the particular data from low-level source data. For example, a program on the server assembles such “sound bites” as do, most commonly, sing the child's name and/or something specific thereto—such as gender, and likewise assembles the particular sentences and/or phrases as are pertinent to personalize the individual-type such as the stories that are on the medium.

In the case personalization data is on a remote server, in one embodiment, everything pertinent to personalizing the individual-type content on the digital medium to the particular child is sent via the Internet from the server to the retail customer's or consumer's computer as the complete personalization data. The personalization program uses the received data to “complete” the media, usually by permanently and irreversibly writing it to a new permanent state after personalization to the particular child. In some embodiments, still further personalized information, such as text and/or graphics suitable for a cover and/or label for the digital medium, e.g., the CD or DVD, personalized with the particular child's name is additionally sent from the server to the retail customer's or consumer's computer. Note that one aspect of some embodiments of the invention is that total amount of personalization information communicated in each direction is modest, and suitable for even a limited-bandwidth connections, such as a dial-up Internet connection and/or slower retail customer's or consumer's computer.

One embodiment includes the possibility that the retail customer's or consumer's computer cannot write the digital medium upon which the content e.g., music and/or stories are initially sold and delivered. In one such embodiment, the personalization information is written to a floppy disk or the like. Note in this regard that, in accordance with the well-known capability of computers to obtain digital files and records that are not in linear sequential order, the personalization information need not be envisioned as being “inserted” into the music and/or story (text) files. Indeed, it is much more likely to be written, as separate records, to the end of a CD or DVD. In accordance with the industry standards for these media, this supplemental “second” recording session “hides”, but does not alter, the originally-recorded information. Appropriate software can still easily and normally retrieve this information—witness the many programs for recovering “lost” data from CDs or DVDs.

A Method for Personalizing Digital Medium Content

In one of its aspects, the present invention is embodied in a method for personalizing digital medium, e.g., one or more optical disks such as a CDs or DVDs containing personalizable content.

Particularly, the method serves to personalize content of interest to children recorded on a digital medium with at least one selected name, therein personalizing said content to a particular child possessing the selected name.

The method includes providing, e.g., by selling and/or delivering, and/or providing access to a retail customer a digital medium, e.g., one or more optical disks such as a CDs or DVDs containing personalizable content of interest to human subjects, e.g., to children. The method further includes providing to the retail customer, e.g., by selling and/or delivering, and/or providing access to a first set of instructions, e.g., a personalization computer carried on a computer-readable carrier medium that when executed on a computer, cause the computer to execute a personalization method, including accepting from a user personal information on a particular human subject, e.g., a particular child, including the particular name of the particular human subject, and modifying the digital medium so that the digital medium contains personalized content of interest to the particular human subject, such that playback of the digital medium on a digital medium playback apparatus provides a human listener with a rendering of the personalized content.

The retail customer or a consumer in possession of the digital medium and computer-readable carrier medium from the retail customer, executes the personalization computer program to implement the personalization method on a computer at a location remote from the location where the retail customer was provided the digital medium. Playback of the content of the digital medium subsequent to the retail customer's or the consumer's implementing the personalization method provides a human listener with a rendering of the personalized content.

In one embodiment, the personalization method includes permanently modifying the digital medium. In this case the executing of the personalization computer program permanently personalizes the digital medium, and subsequent use of the content of the digital medium is permanently personalized with personal information on the particular human subject, e.g., a particular child.

The providing of the digital medium may particularly be of a digital medium in which is contained at least audio content of interest to human subjects such as children. In this case the delivering to the retail customer is of a personalization computer program on a carrier medium that when executed causes the audio content to be personalized with the personal information of the particular human subject, such that upon subsequent playback of the content of the digital medium, at least the name of the particular human subject is invoked in at least an audio rendition of the media.

In one version, the providing of the digital medium to the retail customer is contemporaneous with the providing of the first set of instructions, e.g., the personalization program. For example, in one embodiment, the digital medium includes the personalization program.

In another version, the personalization program is stored in a server remote form the location wherein the retain customer or consumer carries out the localization. In such an implementation, the method includes providing to the user a second set of one or more instructions that when executed on the computer, cause the computer to download the personalization program from the remote server via the Internet, such that the providing of the first set of instructions is by providing a mechanism to download the first set of instructions via the Internet.

A particular version includes first set of instructions containing one or more instructions unique to each particular digital medium.

In the downloading case, in one version, the second set of one or more instructions includes the URL for the downloading via the Internet. The second set of instructions is contained within the digital medium.

One embodiment of the method further includes providing access to a database of content relative to each of a plurality of names, such that the executing of the first set of instructions, e.g., the personalization program causes the computer to access the database of content relative to each of the plurality of names. The access is according to the particular name and provides content relative to a particular one of the plurality of names, such that the personalization is according to the particular one of the plurality of names. Playback of the content of the digital medium subsequent to the retail customer's or consumer's executing the personalization method provides a human listener with a rendering of the content personalized according to the particular one of the plurality of names.

In one version of this method, the digital medium includes the database of content relative to each of the plurality of names, such that the digital medium includes the personalizable content, the first set of instructions and the database of content relative to each of the plurality of names.

In another version of this method, the database of content relative to each of the plurality of names is provided as one or more separate digital media, such that the digital medium includes the personalizable content and the first set of instructions and the separate digital media include the database of content relative to each of the plurality of names.

In one version of this method, the digital medium includes a URL for accessing the database of content relative to each of the plurality of names via the Internet.

The providing, e.g., selling and delivering of the digital medium to the retail customer may be contemporaneous with the providing of the personalization computer program. This contemporaneous delivery of the personalization computer program may be because the personalization computer program is also recorded upon delivered digital medium, may possibly be because the personalization program is contained is the selfsame delivered digital medium upon which the content is also contained.

Alternatively, the delivery of the personalization computer program may be contemporaneous with delivery of the digital medium because a link to where the personalization computer program may be downloaded upon the Internet accompanies the digital medium. In this case the link to where the personalization computer program may be downloaded upon the Internet is, in one embodiment, unique to each copy of the personalization computer program. Most commonly, and easily for a retail customer's use, the link upon the Internet to where the personalization computer program may be downloaded upon the Internet is contained within the digital medium.

Further in the basic method, the delivering to the retail customer may be of, as well as the personalization computer program, a database of content relative to each of plurality of names. In this case the executing is further in a computer in which is accessible the database of content relative to each of the plurality of names, and is further in respect of a particular name selected from the plurality of names of the database as well as being entered into the computer and its executing program. By these steps subsequent playback of the digital medium is personalized to the name selected from among the plurality of names of the database.

The personalization method further includes accepting the content relative to a particular one of the plurality of names obtained by accessing the database, and mixing the accepted content with the personalizable content to form personalized content.

In one embodiment, the content includes at least one part. The access to the database is further according to a particular content part, so that the access provides content relative to a particular one of the plurality of names and relative to the particular content part.

As one example, suppose the content of interest to a human subject, e.g., to a child, includes audio content of interest to children, so that upon subsequent playback of the content of the digital medium, at least the name of the particular child is invoked in at least an audio rendition of the media. Suppose further that the audio content includes audio parts, e.g., different songs. In one embodiment, the access to the database is further according to a particular audio part, and the access provides audio content relative to a particular one of the plurality of names and relative to the particular audio part, e.g., for the particular song. In such an embodiment, the mixing is for each part, e.g., song of the audio content. The mixing for the particular song includes mixing of the particular audio content part with the accepted audio content relative to a particular one of the plurality of names and relative to the particular song.

In one implementation, the digital medium includes the database of content relative to each of the plurality of names. Thus, the digital medium includes the personalizable content, the first set of instructions, and the database of content relative to each of the plurality of names. In one embodiment, the database of content relative to each of the plurality of names included in the digital medium is in protected form, e.g., in encrypted form.

In a different implementation, the digital medium includes the first set of instructions and the personalizable content. The database of content relative to each of the plurality of names is provided as one or more separate digital media. In one embodiment, the database of content relative to each of the plurality of names included in the digital medium is in protected form, e.g., in encrypted form.

In an alternate embodiment, the database of content relative to each of the plurality of names resides on a remote server. The digital medium includes a URL for the accessing of the database via the Internet, and wherein the personalization method includes accessing the database via the Internet for a particular name, and receiving as a result of the access, content relative to a particular one of the plurality of names.

In an alternate embodiment, wherein the digital medium includes a URL for the downloading via the Internet of the database of content relative to each of the plurality of names. In one version, the database of content relative to each of the plurality of names is downloaded in protected, e.g., encrypted form.

In one embodiment, the first set of instructions includes a second set of one or more instructions that when executed on the computer, cause the computer to download from a remote server via the Internet a third set of instructions that that when executed on the computer cause the computer to implement the modifying of the digital medium, e.g., the accepting of the result of accessing the database, and mixing of the accepted result with the personalizable content.

In practice this internet link, e.g., to the proper-name-related database may be contained within the digital medium other than, additional to, and/or supplemental to, that digital medium upon which is contained either the content, the personalization computer program, or both the content and the personalization computer program. And this is also true for the personalization program itself!

It may thus be seen that there are many, and versatile, ways of supplying the retail customer with all software and proper-name-related data necessary to effect personalization of the personalizable content of the digital medium.

A Method of Rendering Personalized Audio to a Human Subject

Another aspect of the invention is a method of rendering personalized audio to a human subject, e.g., a child, and a method of making the personalized audio.

One embodiment is a method of producing personalized audio content on a digital medium, e.g., one or more optical disks such as a CDs or DVDs, the personalized audio content personalized with a human subject's, e.g., a child's information, including the name of the human subject—the child. The method includes providing, e.g., by selling and/or delivering, and/or providing access to a retail customer a digital medium, e.g., one or more optical disks such as a CDs or DVDs containing personalizable but not yet personalized audio content of interest to human subjects, e.g., to children. The method further includes providing to the retail customer, e.g., by selling and/or delivering, and/or providing access to a database containing a plurality of sound clips that are pertinent to a plurality of names of human subjects, e.g., of children. The method further includes providing to the retail customer, e.g., by selling and/or delivering, and/or providing access to a first set of instructions, e.g., a personalization computer program that when executed on a computer, cause the computer to execute a personalization method including accepting from a user personal information on a particular human subject, including the subject's name, accessing the database with the personal information to retrieve one or more sound clips pertinent to the particular human subject, and modifying the digital medium such that the digital medium contains personalized audio content of interest to the particular human subject, such that playback of the digital medium on a digital medium playback apparatus provides a human listener with a rendering of the personalized audio content, including invoking the particular subject's, e.g., child's name. The method is such that the retail customer or a consumer in possession of the digital medium and first set of instruction, and having access to the database can execute the first set of instructions to implement the personalization method on a computer at a location remote from the location where the retail customer was provided the digital medium. Furthermore, the method is such that playback of the content of the digital medium subsequent to the retail customer's or the consumer's implementing the personalization method provides a human listener with an audio rendering of the personalized content.

In one embodiment, the digital medium also includes the first set of instructions, e.g., the personalization program, so that the providing of the digital medium is contemporaneous with the providing of the first set of instructions.

In one embodiment, the providing of the database to the retail customer includes providing a carrier medium carrying information sufficient to access the database.

In one embodiment, the database is carried on a server. The information sufficient to access the database is in such an embodiment information sufficient to access the database on the server via the Internet.

In one embodiment, the providing of the carrier medium is contemporaneous with the providing of the digital medium containing the personalizable audio content and the first set of instructions.

In one embodiment, the carrier medium carries the database, such that the information sufficient to access the database includes the database itself. In one such embodiment, the database is carried on the carrier medium in protected, e.g., encrypted form.

In one embodiment, the first set of instructions, e.g., the personalization program is/are on a server. The providing of the first set of instructions to the retail customer is from the server via the Internet.

In one embodiment, the audio content includes at least one part, e.g., at least one song, and the database includes a plurality of sound clips pertinent to a plurality of names of human subjects and a plurality of content parts. In such an embodiment, the accessing of the database is further for a particular part, such that the access for a particular part for a particular human subject retrieves one or more sound clips pertinent to the particular human subject and to the particular content part. The personalization method for one such version further includes mixing the retrieved sound clips with the particular part of the personalizable audio content to form a personalized audio content part.

A Special Self-Altering and Self-Personalizing Digital Media

In still yet another of its aspects the present invention is embodied in a digital medium, e.g., one or more optical disks such as a CDs or DVDs, interactive with a computer and a computer operator selecting a child's name from a database of content particularized to a plurality of children's names, so as to be both self-altering, and personalizing of its own content. The digital medium includes personalizable content of interest to human subjects, e.g., children, the content initially being without personalization to the name of any one human subject, e.g., one child. The digital medium further includes a first set of computer readable instructions, e.g., a computer program that, when executed by a computer, cause the computer to execute a personalization method. The personalization method includes accepting from an operator particular personal information on a particular human subject, including the particular name of the particular human subject. The personalization method also includes accessing a database of content particularized to a plurality of human subjects' information, including human subjects' names, the accessing with the accepted particular personal information of the particular human subject. The personalization method further includes retrieving from the database content relative to the particular child's particular personal information; and writing the retrieved content onto the selfsame digital medium. The medium and its contents are such that the digital media, after execution of the personalization method, is personalized to the particular human subject, and such the digital media, upon playback plays back content that is personalized to the particular human subject.

In one embodiment, the digital medium includes he actual database of content. That is, the personalizable content, the first set of instructions, and the database are all in the digital medium. In one version, the database is protected, e.g., is in encrypted form.

In one embodiment, the personalizable content of interest to human subjects of includes audio content. As an example, the audio content includes at least one part, e.g., song. The database then includes a plurality of sound clips pertinent to a plurality of names of human subjects and to a plurality of content parts, e.g., songs. The accessing of the database is then further for a particular part, such that the access for a particular part for a particular human subject retrieves one or more sound clips pertinent to the particular human subject and to the particular content part. In one version, the personalization method further includes mixing the retrieved sound clips with the particular part of the personalizable audio content to form a personalized audio content part.

In one embodiment, the database is carried on a server, and the digital medium further includes information sufficient to access the database on the server via the Internet.

The execution of the program for personalization of the contents of the digital medium is, in one embodiment, performed but one time only, to personalize the content with but one single selected child's name. That is, in one embodiment, the personalization method is not executable again after the content has been personalized with for the particular human subject.

### SUMMARY

Thus, in summary, as an example, aspects of the present invention permit a parent or other person at a personal computer to, in a one-time once-only operation, initialize—by supplementary writing—the digital medium to the name and/or other information of a particular child, whereupon the digital medium will thereafter permanently unchangeably play children's music and/or stories, or produce readable stories on a computer monitor or a printer or the like. This personalization is clearly commonly done at a time and a place remote from initial delivery of the digital medium to the retail customer. The store, or seller, is no longer required to personalize digitized music, stories and the like for to a child at, or before, time of delivery.

### BRIEF DESCRIPTION OF THE DRAWINGS

Referring particularly to the drawings for the purpose of illustration only and not to limit the scope of the invention in any way, these illustrations follow:

FIG. 1 shows a simplified schematic block diagram of one embodiment of a system implementing a version of the present invention.

FIGS. 2a and 2b illustrate in the form of tables a process Story Installation with Internet connection that includes aspects of the present invention.

FIGS. 3a and 3b illustrate in the form of tables a process Story Installation without Internet connection that includes aspects of the present invention.

FIGS. 4a and 4b illustrate in the form of tables a process Manage Languages of managing languages that includes aspects of the present invention.

FIGS. 5a and 5b illustrate in the form of tables a process Manage Stories that includes aspects of the present invention.

FIGS. 6a and 6b illustrate in the form of tables a process Manage Children Names that includes aspects of the present invention.

FIG. 7 illustrates in the form of a table a process Map Children Names Between Languages that includes aspects of the present invention.

FIG. 8 illustrates in the form of a table a process Associate Spellings to Children Names that includes aspects of the present invention.

FIG. 9 illustrates in the form of a table a process Manage Application Parameters that includes aspects of the present invention.

FIGS. 10a and 10b illustrate in the form of tables a process Manage CD Serial Numbers that includes aspects of the present invention.

FIG. 11 illustrates in the form of a table a process List Requested Children Names that includes aspects of the present invention.

FIGS. 12a and 12b illustrate in the form of tables a process Administrative Reports that includes aspects of the present invention.

FIGS. 13 to 23 show screen shots showing the interface presented to the retail customer by and with the Story Installation with Internet Connection process that includes aspects of the present invention.

### DETAILED DESCRIPTION

The following description is made for the purpose of illustrating the general principles of the invention, and is not to be taken in a limiting sense. The scope of the invention is best determined by reference to the appended claims.

Although specific embodiments of the invention will now be described with reference to the drawings, it should be understood that such embodiments are by way of example only and are merely illustrative of but a small number of the many possible specific embodiments to which the principles of the invention may be applied. Various changes and modifications obvious to one skilled in the art to which the invention pertains are deemed to be within the spirit, scope and contemplation of the invention as further defined in the appended claims.

As stated in the BACKGROUND section, by the term “retail customer” used throughout this document is meant the final purchaser or a consumer of the digital medium containing personalizable content. This may be, for example, the parent or uncle of a child for whom, and with whose name and other particulars the medium is to be personalized. Note also that the “retail customer” need not always be the actual final purchaser. For example, an uncle may purchase a gift for a parent that includes a digital medium containing personalizable content. The parent receives the gift and may then do the actual personalization. Or the parent may give the received gift to another family member or friend to do the actual personalization.

Demand for the Present Invention

Motivation for the Present Invention

The present invented was motivated by a desire to eliminate the need of a store owner to have a computer for producing personalized stories and music, and to eliminate the need for manpower involved in attending to the retail customer and computer. The assignee of the present invention calls the process of the invention “Grab and Go” because the retail customer can simply pick up an already burned generic CD and personalize the product at home, or give the generic CD to another consumer to personalize at home. This means that the retail store owner can stock a story book CD just like any other CD product.

Demand for the Present Invention

Demand for personalized stories is expected to increase for many reasons, including, we hope, for the following reasons:

Retail customers typically have computers that are connected to or connectable to the Internet and expect to be able to personalize the stories they buy without direct contact with one of the distributors.

The throughput of an Internet solution is much bigger that the face-to-face approach, at much lower costs.

A central database, directly accessed by the clients, is much easier to administer and eliminates the need to redistribute the newly recorded names to all distributors.

Multiple installations from a CD containing a story personalized with a certain name must be limited.

The sales staff and administrators are not being supported with accurate and timely information about the profiles of the retail customers, what names are being required for customization, etc.

Aspects of the present invention have advantages to counteract these shortcomings of the current (2005) methods.

Personalized Music CDs

The present invention deals with providing content on a digital medium, e.g., in the form of one or more CDs or DVDs. Other forms of digital media are known, and the invention may be implemented on a digital medium of a form other than one or more CDs or DVDs, as would be clear to those in the art. The detailed description, however, will concentrate on CDs and DVDs. Similarly, the personalization is typically for a child, but may be for any other human subject. The detailed description, however, will concentrate on personalizing personalizable content of interest to children for a particular child.

Personalizable and personalized digital media products in accordance with embodiments of the present invention are made and sold as CDs (or DVDs) containing music. Accordingly, they are commonly called “personalized music CDs”. The following explanation will thus concentrate on such embodiments. Those in the art will understand that non-music content in the CD or DVD, e.g., textual and video applications are commensurate, and equivalent.

A personalized music CD permits the child's personal information to be inserted into a prerecorded song and thereafter rendered as part of the song. This may be realized by directly “patching” the audio, or encoded audio, files. This is called mixing. Alternatively, a child's name may be created upon initial input using text to speech technology (TTS) and only then inserted into a prerecorded song.

A personalized music CD is, in one embodiment, sold in retail locations. It is an actual CD that is inserted into a computer and is then, in one embodiment, used to access a pre-determined Website of another party, e.g., of the manufacturer, or to otherwise download material from a server maintained by another party, e.g., the manufacturer. In one embodiment, personalization software interacts with the user and with a database on the server to create the personalized CD.

Note that alternatively, it is possible for the entire product to be sold directly and completely off a Website. The retail customer must normally log in using unique personal information. Only then can a personalized CD be first created, e.g., on the third party's servers while the retail customer is online, and then downloaded to the retail customer's computer for direct burning as a CD. Although this “all-Internet” process is operationally expedient, it does require download or voluminous content data by the retail customer, and skills (if not also software) permitting the retail customer to create the CD.

Thus, in one embodiment, the scenario for application of an implementation of the present invention remains that a CD should be provided to the retail customer with the prerecorded personalizable music on it. The personalization data in the form of a content relevant to particular child, e.g., name data for a particular name is, in one embodiment, downloaded by accessing a database that is on a third party's server, e.g., via a primary Website or a secondary music program Website, or directly accessing the server via the Internet.

Note that the database containing the name data could instead accompany the content CD upon initial sale and delivery to the retail customer. However, this name data is normally so extensive as to require at least a second CD. Of course, in this situation there is no need for retail customer Internet connectivity, and no need to ever go online. Furthermore, the name data is typically encrypted when provided in one or more CDs.

The personalization program either provided from the Website or, in one embodiment, delivered with the content disk, serves to insert the child's personal information like name or age, and so forth, into the content part, e.g., the song into predetermined places in the song, creating a song—a content part—that is now complete and personalized by including the child's personal information, e.g., name. We call this process mixing.

This new song is now stored on the user's e.g., the retail customer's or consumer's computer and is able to be burned to a CD for use in any audio device that plays music CD's.

In one version, the mixing occurs on the computer used for personalizing, e.g., at home, while in another version, the mixing occurs on a remote computer, and the resulting complete personalized song is downloaded to the computer.

The included software—either as is deliverable on a digital medium or via the Internet—may include CD burning software needed to burn a CD in the event a retail customer's computer does not have the software to burn a CD but does have a CD burner.

One embodiment of the program also provides a template of a CD label that the retail customer can use to create a personalized label that would be attached to the CD. This label may be like a sticker, or may be printed directly onto the CD using a CD printer.

Interactive CD ROM Story Books

Aspects of the present invention are also embodied in CD ROM Story Books. Such an embodiment of the invention is manufactured to be sold as a personalizable and Interactive Audio CD Story Book or game. As an example, a CD is sold in a retail location, online or any other location where products are sold. The CD contains personalizable content including personalizable text, as well as a software program or, in one embodiment, access to a software program that is located remotely on a server. The executing of the program implements a personalization method to personalize the content, e.g., as part of creating the main character(s) of the story or game. Commonly a series of scenes that contain the personalizable text and graphics can be personalized at a time and location that can be different from where the retail customer obtained the CD. The personalization method alters the content depending on the information provided by a computer user, e.g., the retail customer or another consumer.

As one example, the retail customer purchases a CD, the retail customer or consumer inserts the CD into a computer and accesses the program using a single use access code provided with the CD. After the retail customer or consumer inputs some required information, he or she can begin to create the main characters of the story or game by changing personal features such as gender, ethnicity, hair color, and eye color. This can include personal information about a particular child.

The retail customer or consumer commonly also inputs other personal information about the particular child to create the personalized story. In one version, the personal information is used to access a database, e.g., located on a server wherefrom relevant and personalized to the particular child is downloaded into the program from a location on the Internet, e.g., via Website. In an alternate embodiment, the database is provided separately. The character(s) that were created from data provided by the retail customer or consumer are mixed with the personalizable story, e.g., inserted into the story. For example, the personalized text of the story is created using the personalizable text that was on the CD, and the personal information that was provided by the retail customer or consumer.

Creating a CD that reads a story to the child including the information provided in the storyline and the main characters on the screen represent the physical characteristics selected by the retail customer or consumer. In one version, the text is read using human voices which were prerecorded and stored as audio files or Text-to-Speech (TTS) technology.

In one embodiment, the CD with the Story Book or game is inserted into a computer and used to access a server on the Internet, e.g., via a Website. The Website allows the user to create the personalized text and characters. In another implementation, the product is sold directly off a Website where the retail customer logs in and provides personal information about the child. A program at a server accessed via the Website creates the CD information while the user is online. A program on the CD provides information to download the personalized information to the computer and/or burn the information directly to a CD using a CD burner on the computer. Thus, it will also be possible to log onto a Website to make a personalized CD without needing to go to the store and buy a CD first.

The CD is sold with the prerecorded and personalizable story, text and graphics on it. The name or other personal information, physical characteristics of the top characters are either downloaded from a Website or created using a provided program. In some embodiments, a multiple 2 CD set is provided, so that there is no need to go online.

The program from the Website or provided software disk mixes the child's personal information such as name, age, and/or other information with the personalizable story by inserting corresponding information at predetermined places in the story, creating a personalized story that is complete and includes the particular child's information. In one embodiment, the program inserts characters that were created by the user into the graphics in predetermined places. Upon playback of the story, the listener/viewer will see the characters that have been created, read or have read to him or hear the text of the story that includes their personal information. The hearing of the text is of text read aloud by a human or TTS that includes the personal information. Note that the term information is used here, so that, in the case TTS is used, several variables can be inserted.

This new story is now downloaded and stored on the retail customer's computer or the original CD.

One embodiment of the program also provides, as before, a template of a CD label that the retail customer can use to create a personalized label that would be attached to the CD like a sticker or printed directly onto the CD using a CD printer.

Personalized Activity Books

Aspects of the present invention can also be embodied in personalized activity books. Activity books are defined as books where the child must use his or her hands, as well as eyes, to perform the “exercises” of the book.

Features of Some Embodiments of the Present Invention

Features/Operation of a Storybook CD in Accordance with the Present Invention

By way of example, the features/operation of a storybook CD that includes aspects of the present invention are now described.

A CD is purchased. The CD jewel case has a sticker that has a serial number. Upon insertion of the CD in a computer, an installation wizard starts up.

The installation wizard collects a particular child's name and connects to a remote server via the Internet in order to automatically download an audio file of that child's name from an online database.

The installation wizard further allows the user, e.g., a consumer or the purchaser, or even the child, to choose the child's personal attributes from visual cues: including gender, eye color, skin color, face type, hair color, and hair style.

The installation wizard further copies story book elements such as framework, artwork, sound files and related files from the inserted CD.

The installation wizard assembles the story book elements with the audio file of that child's name and the chosen personal attributes in order to compile the final story book on the computer hard disk drive.

Fifth, the user enters the serial number from the Jewel case of the CD to the installation wizard. This serial number is uploaded to the online database and ensures that the CD is not used illegally to build story books for more than one child.

Features/Operation of a Music CD that Includes Aspects of the Present Invention

By way of example, the features/operation of a music CD that includes aspects of the present invention are now described.

A CD is purchased. The CD jewel case has a sticker that has a serial number. The CD includes a program we call the installation wizard, and several personalizable songs. A personalizable song is a song that is complete, except for one or more sung versions of a child's name that need to be added at pre-determined locations called mixing points, in the song.

Upon insertion of the CD in a computer, the installation wizard starts up.

The installation wizard requests from the user and collects a particular child's name and connects to a remote server via the Internet in order to automatically download for each audio song on the CD one or more audio files, e.g., WAV files, each of that child's name as sung for that song for mixing at each mixing point for the song from an online database.

The database provides for each child of a set of many, e.g., several thousand children's names, for each song of a set of songs, and for each mixing point of the song: a WAV file of the child's name sung for that song for that mixing point.

The installation wizard loads instrumental track and voice track of songs from the CD to the memory and/or hard disk drive of the computer. These songs are personalizable in that are each missing phrases from the voice track at the respective mixing points that should include a child's name and a word or two before and after. The songs are otherwise complete, and are even playable in the personalizable form prior to personalization.

The installation wizard mixes each personalizable song with the downloaded audio files of that child's name for that song at each of the mixing points of the song in order to produce a personalized song for the particular child.

A personalized CD burn application is included for burning the child's songs to a blank CD.

An Exemplary Process for Making Music Files and the Database Used in an Embodiment of the Present Invention

A description of one embodiment of a process for making the music files is as follows:

1) A musician or musicians record the instrumental track.

2) One or more vocalists record voice track on top of instrumental track, but omit phrases that include a child's name. Each phrase occurs at a respective mixing point in time which is marked, e.g., by a time indication. A phrase is one or two words before and after the child name.

The result of steps 1 and 2 is a single musical file, e.g., a WAV file of a personalizable song. This personalizable song forms part of the personalizable audio content that is on the to-be-sold CD. The to-be-sold CD includes a computer program to implement the personalization, e.g., the installation wizard described above. For each song, there is time information on the mixing points and the length of the missing phrases. The timing information, in one embodiment, is also on the CD, while in another embodiment, the timing information is stored on a server and retrieved online when accessing a database for name phrases for mixing with the personalizable song.

3) For a set of children, for each song, one or more vocalists listen to a instrumental track, e.g., using earphones and record voice tracks of phrases that include the child's name as appropriate for inclusion in the song at the respective mixing points. These form small audio files, e.g., WAV files for each child, for each mixing point in the song.

4) Steps 1) through 3) are repeated for each child phrase for each mixing point in each song for all the children in the set.

This results in a database of child name phrases that we put in a database indexed by the child's name and the song and the phrase instance and mixing time. In one version, the database is put on a server accessible online.

A retail customer or consumer purchases a CD and inserts the CD in a computer. That causes a program, e.g., the above-described installation wizard to execute. Execution includes downloading the child name phrases for each song for the mixing points of the song as audio files, and mixing the downloaded files with the song(s) on the CD.

Elements of One Implementation of a System that Includes Aspects of the Present Invention

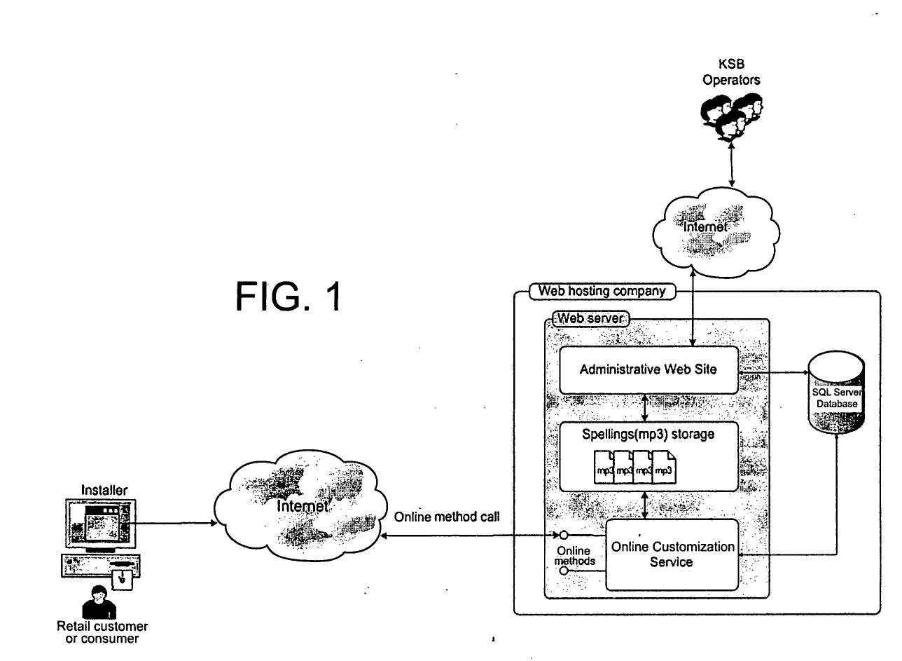

A simplified schematic block diagram of one embodiment of a system implementing the present invention is shown in FIG. 1.

In this and in following drawings, “KSB” stands for “Children Story Book” and, when applied to the word “operators” as in “KSB operators”, means those human individuals representing the manufacturer that in part operate the system. The other system “operative” is the “Retail customer”.

Online Database

In one embodiment, an online database of sounds and other content particular to parts and to specific information, e.g., children's names is maintained. Maintaining the online database provides the manufacturer/operator the ability to upload new child names individually to the online database. Maintaining the online database further provides the ability to reissue a child's name in case of bad pronunciation, retail customer mistake, new computer, etc.

Another aspect of some embodiments is that a database of all retail customers can be maintained by the manufacturer/operator. Furthermore, using an Internet-based online activation process should ensure that someone hasn't used the same CD to install a story on two different computers.

Design Goals and Constraints

The following are some design goals and constraints of a system that is used commercially and that includes aspects of the present invention.

Performance

Processor utilization does not exceed 80 percent during spikes of 100 concurrent users running the installer for the story.

Availability

Because the customization/personalization server is accessed by retail customers across the world, it needs to be available 24 hours a day, 7 days a week.

An Administration Website is maintained and accessed by the Manufacturer's operators for database maintenance and other such functions. Such a Website needs to be available during their business hours.

Reliability

Because of the need for 24/7 availability, automatic failover is preferred in a commercial operation. In addition, disaster recovery and backup plans and procedures should be created.

Scalability

It is envisaged that a single commercial system supports an average load of 100 concurrent users running the installer for the story. In 2005, and this is expected to grow by 10 percent each year for the next three years.

Security

The sensitive information, e.g., recorded names will be encrypted while being transferred over the Internet and will not be stored on the client computer until a successful installation.

Authentication on the Administration Website will be done using .Net Forms Authentication over SSL (server certificate).

Interoperability

There are no requirements for interoperability with other systems.

Location

The Administration Website will be located at a hosting provider and will be accessed by the Manufacturer's operators using Internet Explorer 5.5 and above.

The online personalization service described herein can be used by retail customers or consumers using a range of Windows or Mac operating systems in a variety of locations around the world.

Internationalization

The story installation wizard needs to support international character sets and date/time formats.

Setup/Installation

The online personalization service and the Administration Website will be installed at a hosting provider.

A migration of the current names database and sound file into the new system will be done.

Assumptions and Constraints

The installer of the story will run on Windows 98 SE and above.

The online personalization service described herein and the Administration Website will run on Windows 2000 Server or Windows 2003 Server, using .NET Framework 1.1. They will both be using the names database running on SQL Server 2000 Standard or Enterprise Edition.

Features and Functionality

One software embodiment of a commercial operation includes two main modules:

The first is what is called the story installer. See the above descriptions of the installation wizard for each of a story CD and an audio CD. The story installer, in turn, includes the actual Windows Installer and provides access to the online database for the personalization. The second is the Administrative Website which allows the KSB operators to manage recorded names and CD serial numbers.

The Story Installer

Install Using an Internet Connection

This function will allow the retail customer to install and personalize a personalizable story on a CD using the online personalization service over an Internet connection.

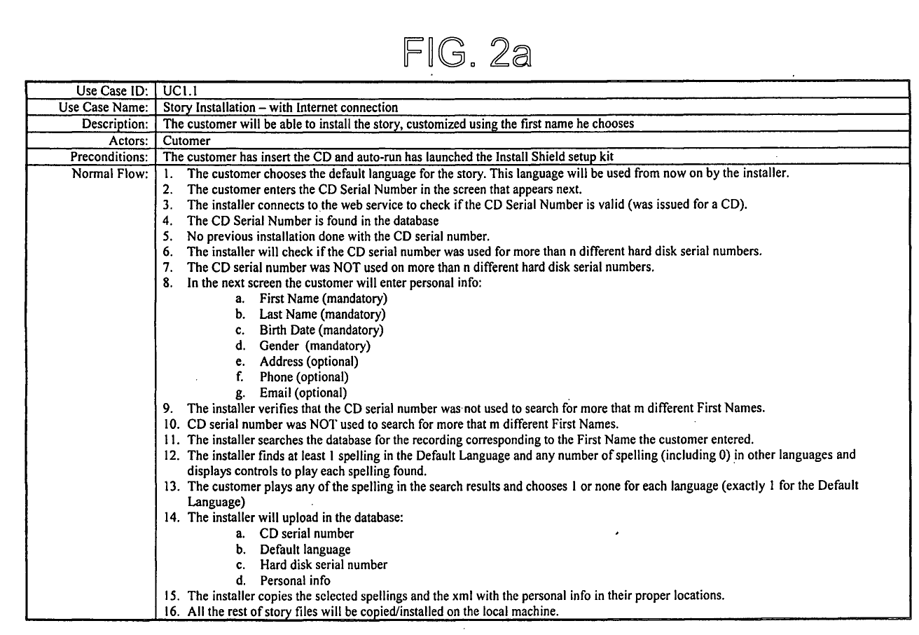

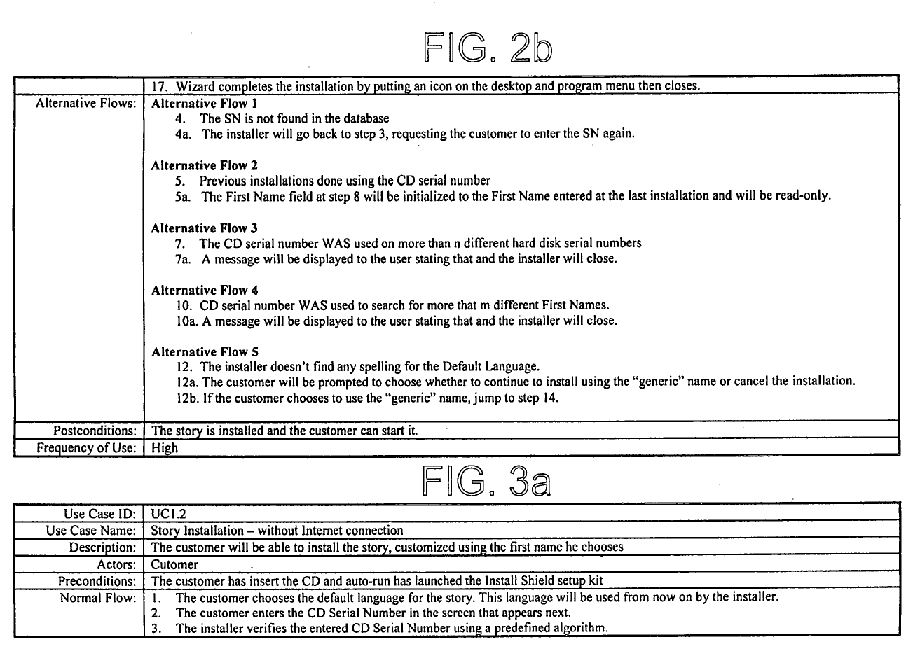

The process usage scenario is described in Use Case UC1.1—Story Installation with Internet connection is shown in Table 2 of FIG. 2, consisting of FIGS. 2a and 2b.

In one implementation, the number of searches per CD serial number is limited. In the database we are going to store, for every CD serial number, a list of distinct First Names that were searched for. This list will be a global one, no matter how many times the user installed the product. Whenever the user searches for a name, if the search returned any spellings, the name is inserted in the database for that serial number.

If the size of this list reaches the value of the application parameter that specifies the maximum number of distinct names the user can search for, then the user cannot search for other names so he cannot install the product using a name that is not on the list.

Before every search, after the Personal Info screen, the user is warned that, if he goes on with the search, he will be able to do no more searches. Also, a list of names he previously searched for is displayed.

Install Using a Customization CD

This function will allow the retail customer to install and personalize the story using the CD he received after providing the personal info to the Manufacturer's operators.

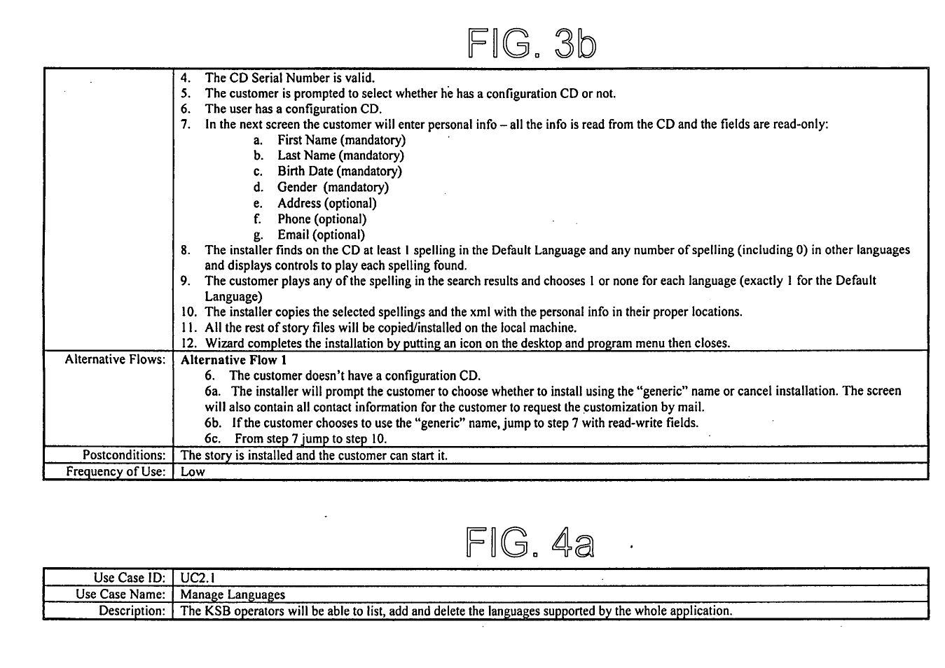

For the process the usage scenario is described in Use Case UC1.2—Story Installation without Internet connection, shown in Table 3 of FIG. 3, consisting of FIGS. 3a and 3b.

Administrative Website

Manage Languages

This function permits manufacturer's personnel to create, maintain, and delete languages supported by the whole application, e.g., all the stories. Managing the languages globally and then associating them to certain stories is necessary if reports involving aggregations on languages, like how many installations were done in English, for any story, are required.

The process usage scenario is described in Use Case UC2.1—Manage Languages. This process is shown in Table 4 of FIG. 4, consisting of FIGS. 4a and 4b.

Manage Stories

This function allows KBS operators to create, maintain, and delete information about stories.

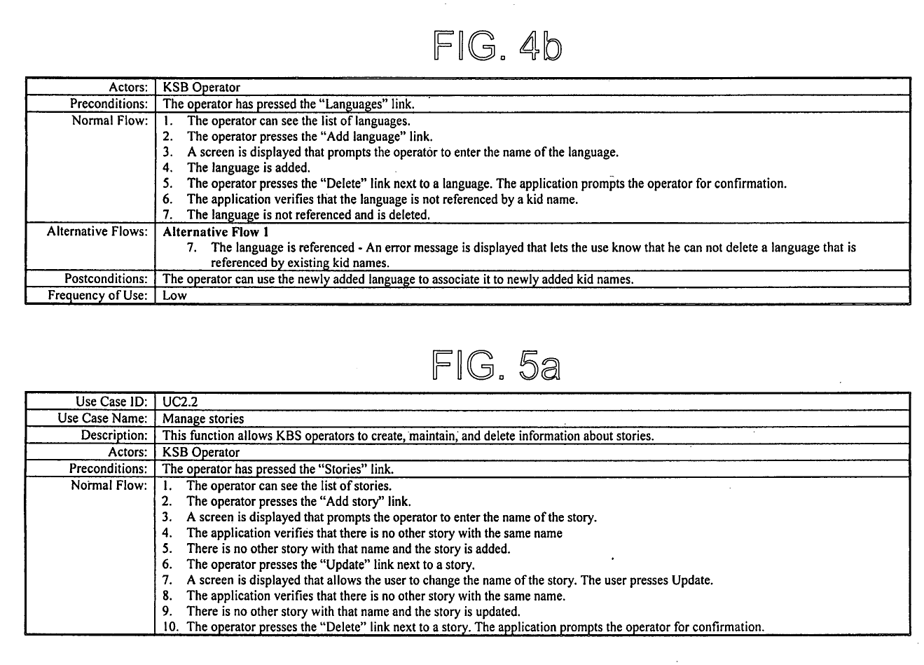

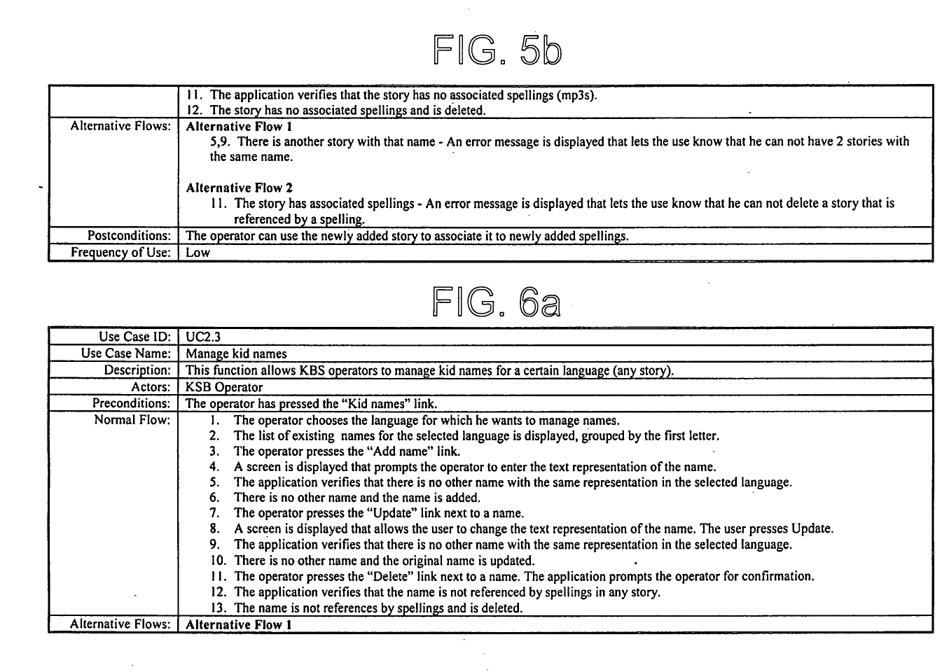

The process usage scenario is described in Use Case UC2.2—Manage Stories. This process is shown in Table 5 of FIG. 5, consisting of FIGS. 5a and 5b.

Manage Child Names

This function allows KBS operators to manage child names for a certain language for any story.

The process usage scenario is described in Use Case UC2.3—Manage child names.

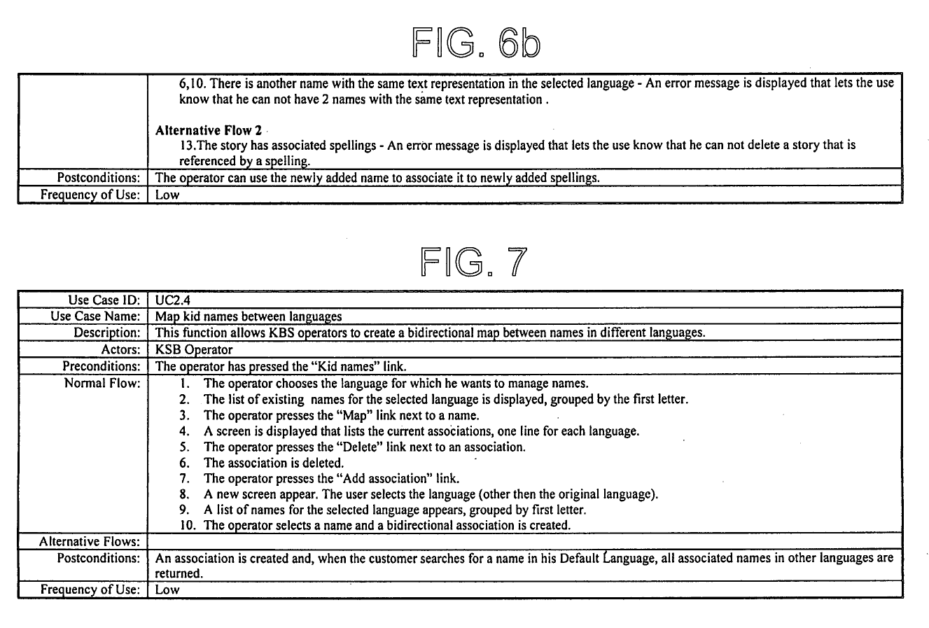

This process is shown in Table 6 of FIG. 6, consisting of FIGS. 6a and 6b.

Map Child Names Between Languages

This function allows KBS operators to create a bidirectional map between names in different languages.

The process usage scenario is described in Use Case UC2.4—Map child names between languages. This process is shown in Table 7 of FIG. 7.

Associate Spellings (MP3) to Child Names

This function allows KSB operators to associate—and disassociate—sound files to names and stories either by uploading them or selecting an already uploaded file.

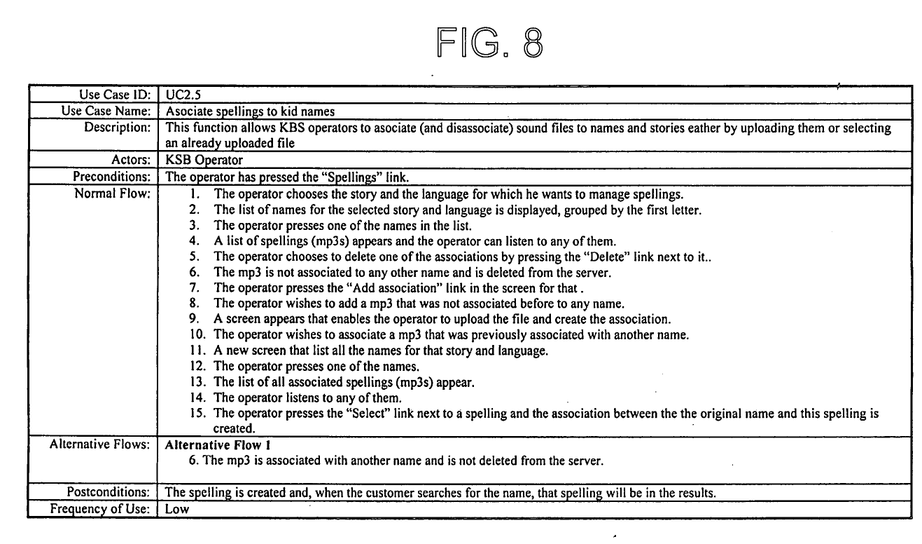

The Process usage scenario is described in Use Case UC2.5—Associate spellings to child names. This process is shown in Table 8 of FIG. 8.

Manage Application Parameters

This function allows KSB operators to manage parameters like:
The maximum number of times the retail customer can install the story on different hard disks.
The maximum number of times the retail customer can search for different child names, etc;

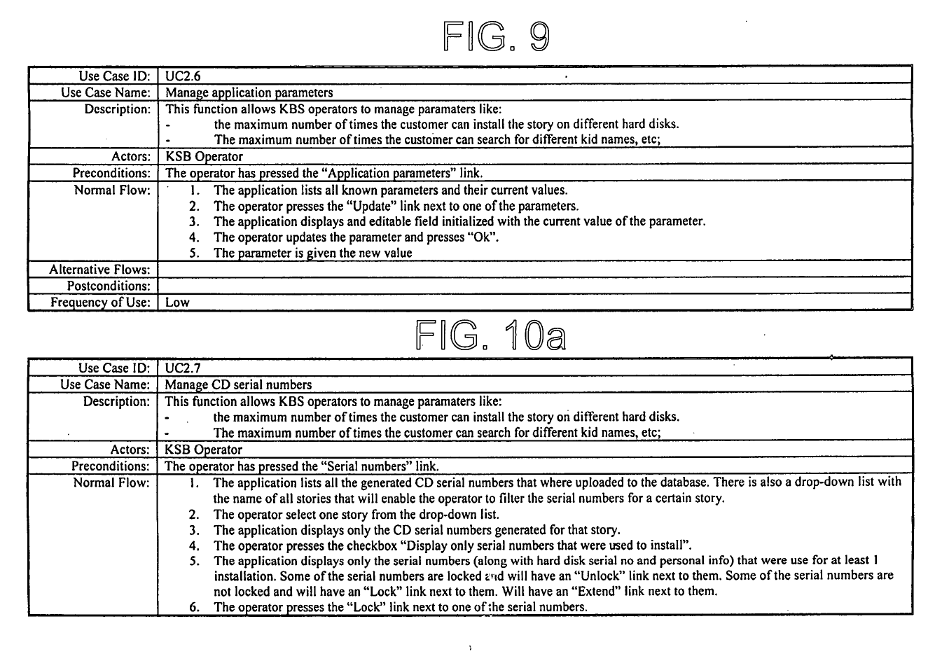

The process usage scenario is described in Use Case UC2.5—Manage application parameters. This process is shown in Table 9 of FIG. 9.

Manage CD Serial Numbers

The Manage CD serial numbers function allows KSB operators to list all generated CD serial numbers; list only CD serial numbers that were used for an installation; add valid generated CD serial numbers; and lock/unlock/extend a specified CD serial number from further receiving its related audio child name audio files.

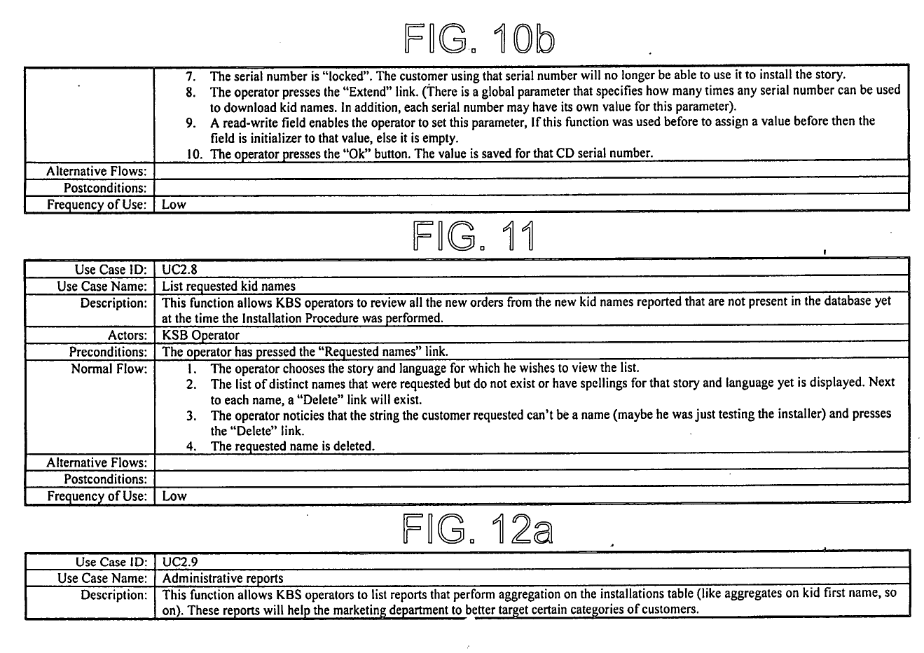

The process usage scenario is described in Use Case UC2.7—Manage CD serial numbers. This process is shown in Table 10 of FIG. 10, consisting of FIGS. 10a and 10b.

List Requested Child Names

This function allows KSB operators to review all the new orders from the new child names reported that are not present in the database yet at the time the Installation Procedure was performed.

The process usage scenario is described in Use Case UC2.8—List requested child names. This process is shown in Table 11 of FIG. 11.

Administrative Reports

This function allows KBS operators to list reports that perform aggregation on the installations table—like aggregates on child first name, and so on. These reports will help the marketing department to better target certain categories of retail customers.

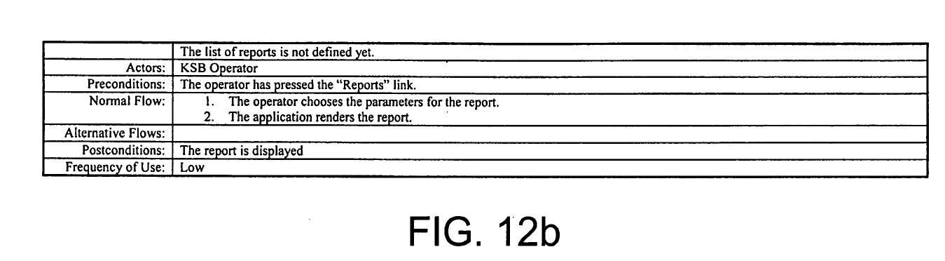

The process usage scenario is described in Use Case UC2.9—Administrative reports. This process is shown in Table 12 of FIG. 12, consisting of FIGS. 12a and 12b.

Solution Architecture

Infrastructure

The server that hosts the online personalization service and the Administrative Website will have a 2.4 GHz Intel Xeon Processor or equivalent. The operating system software will be Microsoft Windows 2003 Standard or above with the latest service pack. The database will be Microsoft SQL Server 2000, with the latest service pack.

Visual Design

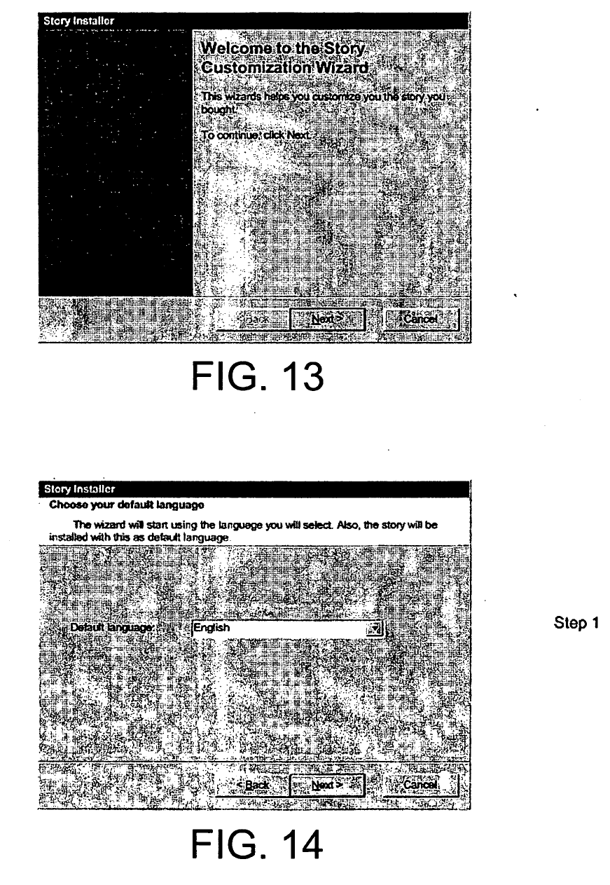

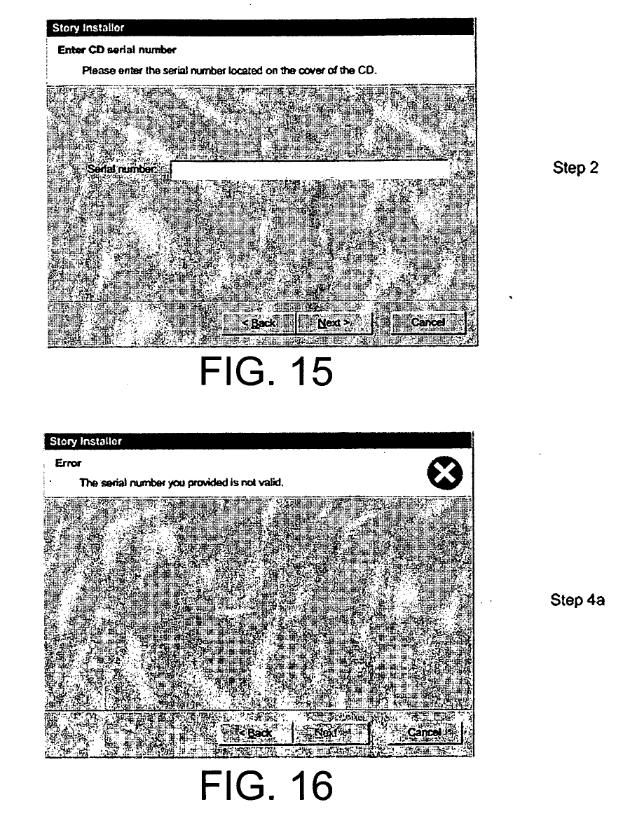

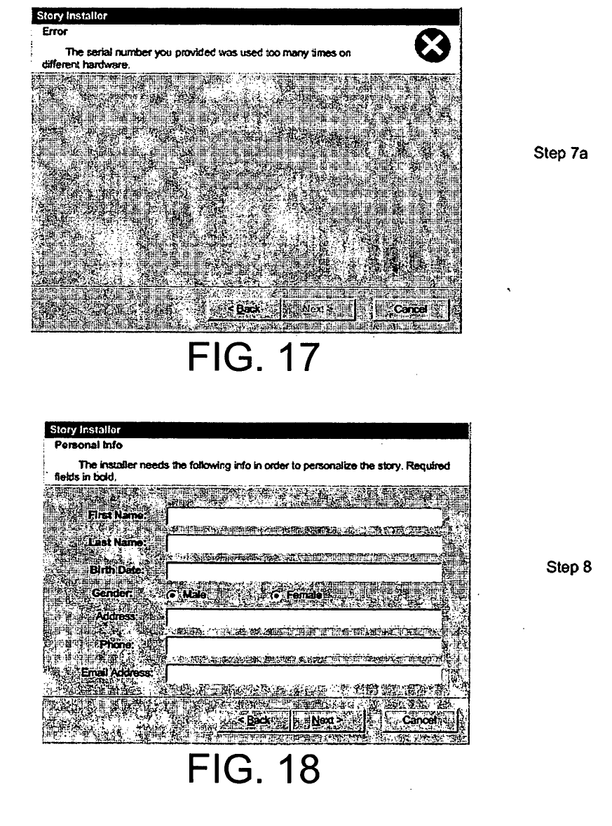

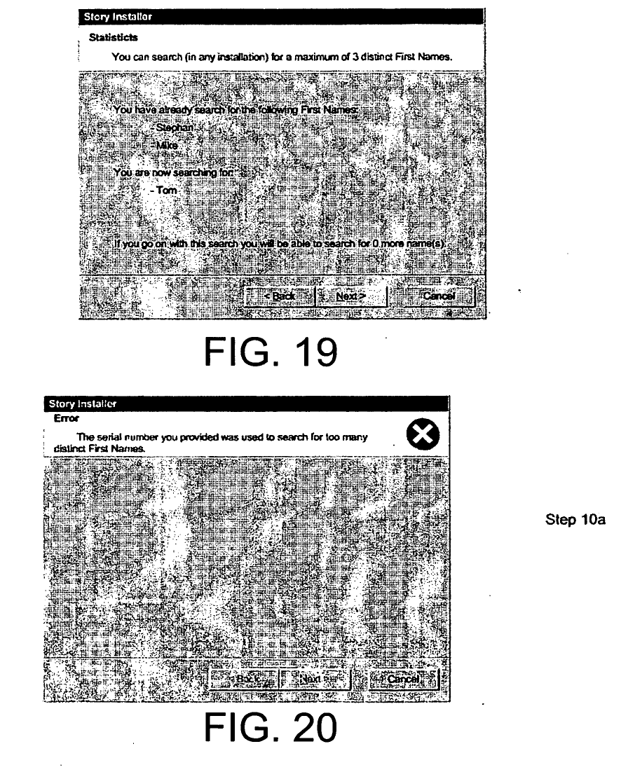

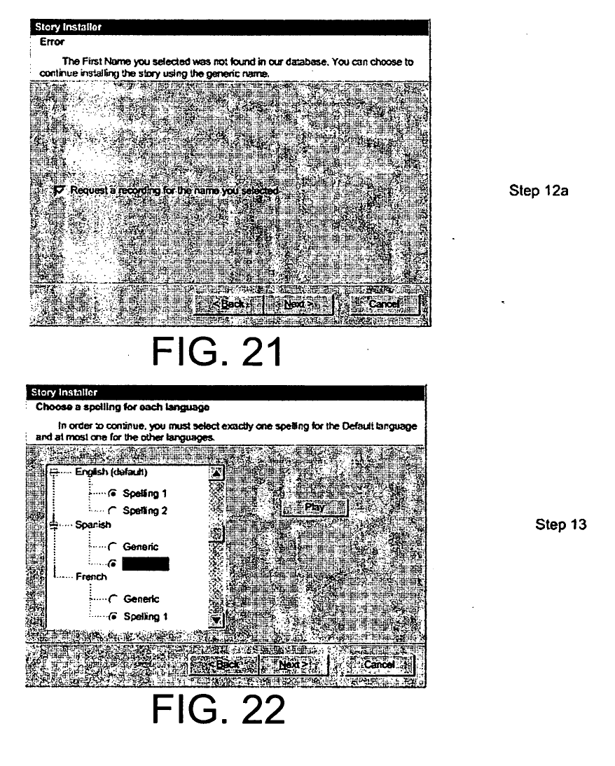

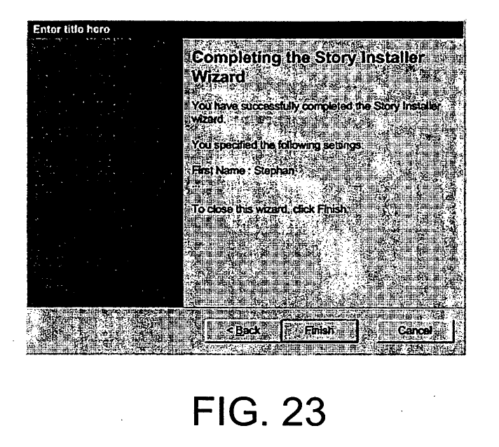

The visual design of one embodiment of the system as seen by the Retail customer—see FIG. 1—is shown in the screen shots of FIGS. 13-23.

Conclusion

In accordance with the preceding explanation, variations and adaptations of the personalization system in accordance with the present invention will suggest themselves to a practitioner of the computer sciences.

For example, it is possible to use the system for personalization of content other than is (primarily) directed towards children.

For example, it is possible to personalize media obtained by other than purchase, such as by downloading material from the Internet, and there need not be a one-to-one correspondence between the personalization program and the contents, and the media, ultimately personalized.

Unless specifically stated otherwise, as apparent from the description herein, it is appreciated that throughout the specification discussions utilizing terms such as “processing,” “computing,” “calculating,” “determining” or the like, refer to the action and/or processes of a computer or computing system, or similar electronic computing device, that manipulates and/or transforms data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by a machine such as a computer that includes one or more processors that accept computer-readable (also called machine-readable) instructions, e.g., software. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more CPUs, a graphics processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD) or a cathode ray tube (CRT) display. If manual data entry is required, the processing system also includes an input device such as one or more of an alphanumeric input unit such as a keyboard, a pointing control device such as a mouse, and so forth. The term memory unit as used herein also encompasses a storage system such as a disk drive unit. The processing system in some configurations may include a sounds output device, and a network interface device. The memory subsystem thus includes a carrier medium that carries computer-readable instructions, e.g., software, for performing, when executed by the processing system, one or more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute carrier medium carrying computer-readable instructions.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be a personal computer (PC), a tablet PC, a set-top box (STB), a Personal Digital Assistant (PDA), a cellular telephone, a Web appliance, a network router, switch or bridge, or any machine capable of executing a set of instructions (sequential or otherwise) that specify actions to be taken by that machine.

Note that while some diagram(s) only show(s) a single processor and a single memory that carries the computer-readable instructions, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer program that executes on a processing system, e.g., a one or more processors that are part of a computer, as appropriate. Thus, as will be appreciated by those skilled in the art, embodiments of the present invention may be embodied as a method, an apparatus such as a special purpose apparatus, an apparatus such as a data processing system, or a carrier medium, e.g., a computer program product. The carrier medium carries computer readable instructions for controlling a processing system to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program instructions embodied in the medium.

The software may further be transmitted or received over a network via the network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by the machine and that cause the machine to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media may also take the form of acoustic or light waves, such as those generated during radio wave and infrared data communications. For example, the term “carrier medium” shall accordingly be taken to include, but not be limited to, solid-state memories, optical and magnetic media, transmission media, and carrier wave signals.

It will be understood that the steps of methods discussed are performed in one embodiment by an appropriate processor (or processors) of a processing (i.e., computer) system executing instructions (code segments) stored in storage. It will also be understood that the invention is not limited to any particular implementation or programming technique and that the invention may be implemented using any appropriate techniques for implementing the functionality described herein. The invention is not limited to any particular programming language or operating system.

In the description herein, numerous specific details are set forth. However, it is understood that embodiments of the invention may be practiced without these specific details. In other instances, well-known methods, structures and techniques have not been shown in detail in order not to obscure an understanding of this description.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable manner, as would be apparent to one of ordinary skill in the art from this disclosure, in one or more embodiments.

Similarly, it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

What is claimed is:

1. A method of personalizing content recorded on a digital medium, the method comprising:
providing to a retail customer a digital medium containing personalizable content of interest to human subjects; and
providing to the retail customer a first set of instructions that when executed on a computer, cause the computer to execute a personalization method, including accepting from a user personal information on a particular human subject, including the particular name of the particular human subject, and modifying the digital medium so that the digital medium contains personalized content of interest to the particular human subject, such that playback of the digital medium on a digital medium playback apparatus provides a human listener with a rendering of the personalized content,
such that the retail customer or a consumer in possession of the digital medium and the first set of instructions, is able to implement the personalization method on a computer at a location remote from the location where the retail customer was provided the digital medium, and
such that playback of the content of the digital medium subsequent to the retail customer's or the consumer's implementing the personalization method provides a human with a rendering of the personalized content.

2. A method as recited in claim 1, wherein the personalization method includes permanently modifying the digital medium.

3. A method as recited in claim 1, wherein the content of interest to a human subject includes audio content of interest to human subjects, such that upon subsequent playback of the content of the digital medium, at least the name of the particular human subject is invoked in at least an audio rendition of the media.

4. A method as recited in claim 1, wherein the providing of the digital medium to the retail customer is contemporaneous with the providing of the first set of instructions.

5. A method as recited in claim 4, wherein the digital medium includes the first set of instructions.

6. A method as recited in claim 4, further comprising providing to the user a second set of one or more instructions that when executed on the computer, cause the computer to download from a remote server via the Internet the first set of instructions that that when executed on the computer cause the computer to implement the modifying of the digital medium, such that the providing of the first set of instructions is by providing a mechanism to download the first set of instructions via the Internet.

7. A method as recited in claim 6, wherein the first set of instructions contains one or more instructions unique to each particular digital medium.

8. A method as recited in claim 6, wherein the second set of one or more instructions includes the URL for the downloading via the Internet, and wherein the second set is contained within the digital medium.

9. A method as recited in claim 1, further comprising providing access to a database of content relative to each of a plurality of names,
such that the personalization method includes accessing the database of content relative to each of the plurality of names, the access according to the particular name, the access providing content relative to a particular one of the plurality of names, such that the personalization is according to the particular one of the plurality of names, and
such that playback of the content of the digital medium subsequent to the retail customer's or consumer's executing the personalization method provides the human with a rendering of the content personalized according to the particular one of the plurality of names.

10. A method as recited in claim 9, wherein the content includes at least one part, and wherein the access is further according to a particular content part, such that the access provides content relative to a particular one of the plurality of names and relative to the particular content part.

11. A method as recited in claim 9, wherein the personalization method further includes:
accepting the content relative to a particular one of the plurality of names; and
mixing the accepted content with the personalizable content to form personalized content.

12. A method as recited in claim 11,
wherein the content of interest to a human subject includes audio content of interest to human subjects, such that upon subsequent playback of the content of the digital medium, at least the name of the particular human subject is invoked in at least an audio rendition of the media, and
wherein the audio content includes at least one audio part, and wherein the access is further according to a particular audio part, such that the access provides audio content relative to a particular one of the plurality of names and relative to the particular audio part,
such that the mixing is for each part of the audio content, the mixing for the particular audio part including mixing of the particular audio content part with the accepted audio content relative to a particular one of the plurality of names and relative to the particular audio part.

13. A method as recited in claim 9, wherein the digital medium includes the database of content relative to each of the plurality of names, such that the digital medium includes the personalizable content, the first set of instructions and the database of content relative to each of the plurality of names.

14. A method as recited in claim 13, wherein the database of content relative to each of the plurality of names included in the digital medium is in encrypted form.

15. A method as recited in claim 9, wherein the database of content relative to each of the plurality of names resides on a remote server, wherein the digital medium includes a URL for the accessing of the database via the Internet, and wherein the personalization method includes accessing the database via the Internet for a particular name, and receiving as a result of the access, content relative to a particular one of the plurality of names.

16. A method as recited in claim 9, wherein the digital medium includes a URL for the downloading via the Internet of the database of content relative to each of the plurality of names.

17. A method as recited in claim 16, wherein the database of content relative to each of the plurality of names is downloaded in encrypted form.

18. A method as recited in claim 9, wherein the digital medium includes the first set of instructions such that the digital medium includes the personalizable content and the first set of instructions.

19. A method as recited in claim 18, wherein the database of content relative to each of the plurality of names is provided as one or more digital media separate from the digital medium in which the personalizable content and the first set of instructions are included.

20. A method as recited in claim 19, wherein the database of content relative to each of the plurality of names included in the separate digital media is in encrypted form.

21. A method as recited in claim 9, wherein the first set of instructions includes a second set of one or more instructions that when executed on the computer, cause the computer to download from a remote server via the Internet a third set of instructions that that when executed on the computer cause the computer to implement the modifying of the digital medium.

22. A method as recited in claim 21, further comprising providing to the retail customer an additional digital medium containing a URL to the server on the Internet wherefrom the third set of instructions is downloadable.

23. A method as recited in claim 1, wherein the digital medium includes one or more optical disks.

24. A method of producing personalized audio content on a digital medium, the personalized audio content personalized with a human subject's information, including the name of the human subject, the method comprising:
providing to a retail customer a digital medium containing personalizable but not yet personalized audio content of interest to human subjects;
providing to the retail customer a database containing a plurality of sound clips that are pertinent to a plurality of names of human subjects; and
providing to the retail customer a first set of instructions that when executed on a computer, cause the computer to execute a personalization method including accepting from a user personal information on a particular human subject, including the subject's name, accessing the database with the personal information to retrieve one or more sound clips pertinent to the particular human subject, and modifying the digital medium such that the digital medium contains personalized audio content of interest to the particular human subject, such that playback of the digital medium on a digital medium playback apparatus provides a human listener with a rendering of the personalized audio content, including invoking the particular subject's name,
such that the retail customer or a consumer in possession of the digital medium and first set of instructions, and having access to the database can execute the first set of instructions to implement the personalization method on a computer at a location remote from the location where the retail customer was provided the digital medium, and
such that playback of the content of the digital medium subsequent to the retail customer's or the consumer's implementing the personalization method provides a human listener with an audio rendering of the personalized content.

25. A method as recited in claim 24, wherein the personalization method includes permanently modifying the digital medium.

26. A method as recited in claim 24,
wherein the digital medium also includes the first set of instructions, such that the providing of the digital medium is contemporaneous with the providing of the first set of instructions.

27. A method as recited in claim 26,
wherein the providing of the database to the retail customer includes providing a carrier medium carrying information sufficient to access the database.

28. A method as recited in claim 27,
wherein the database is carried on a server and wherein the information sufficient to access the database is information sufficient to access the database on the server via the Internet.

29. A method as recited in claim 27,
wherein the providing of the carrier medium is contemporaneous with the providing of the digital medium containing the personalizable audio content and the first set of instructions.

30. A method as recited in claim 27,
wherein the carrier medium carries the database, such that the information sufficient to access the database includes the database.

31. A method as recited in claim 30,
wherein the carrier medium carries the database in encrypted form.

32. A method as recited in claim 24,
wherein the first set of instructions is on a server and wherein the providing of the first set of instructions to the retail customer is from the server via the Internet.

33. A method as recited in claim 32,
wherein the providing of the database to the retail customer includes providing a carrier medium carrying information sufficient to access the database.

34. A method as recited in claim 24, wherein the audio content includes at least one part, wherein the database includes a plurality of sound clips pertinent to a plurality of names of human subjects and a plurality of content parts, wherein the accessing of the database is further for a particular part, such that the access for a particular part for a particular human subject retrieves one or more sound clips pertinent to the particular human subject and to the particular content part.

35. A method as recited in claim 34, wherein the personalization method further includes:
mixing the retrieved sound clips with the particular part of the personalizable audio content to form a personalized audio content part.

36. A method as recited in claim 24, wherein the digital medium includes one or more optical disks.

37. A digital medium interactive with a computer and a computer operator selecting a human subject's name from, so as to be both self-altering, and personalizing of its own content, the digital medium comprising:
personalizable content of interest to human subjects, the content initially being without personalization to the name of any one human subject;
a first set of computer readable instructions that, when executed by a computer, cause the computer to execute a personalization method, the method including:
accepting from an operator particular personal information on a particular human subject, including the particular name of the particular human subject;
accessing a database of content particularized to a plurality of human subjects' information, including human subjects' names, the accessing with the accepted particular personal information of the particular human subject;
retrieving from the database content relative to the particular human subject's particular personal information; and
writing the retrieved content onto the selfsame digital medium, such that the digital media, after execution of the personalization method, is personalized to the particular human subject, and such the digital media, upon playback plays back content that is personalized to the particular human subject.

38. A digital medium as recited in claim 37, further comprising:
the database of content,
such that the personalizable content, the first set of instructions, and the database are all in the digital medium.

39. A digital medium as recited in claim 37, wherein the database is in encrypted form.

40. A digital medium as recited in claim 37,
wherein the personalizable content of interest to human subjects includes audio content.

41. A digital medium as recited in claim 40, wherein the audio content includes at least one part, wherein the database includes a plurality of sound clips pertinent to a plurality of names of human subjects and a plurality of content parts, wherein the accessing of the database is further for a particular part, such that the access for a particular part for a particular human subject retrieves one or more sound clips pertinent to the particular human subject and to the particular content part.

42. A digital medium as recited in claim 41, wherein the personalization method further includes:
mixing the retrieved sound clips with the particular part of the personalizable audio content to form a personalized audio content part.

43. A digital medium as recited in claim 37,
wherein the personalization method is not executable again after the content has been personalized with for the particular human subject.

44. A digital medium as recited in claim 37, comprising:
one or more optical disks.

45. A digital medium as recited in claim 37,
wherein the database is carried on a server, the digital medium further comprising:
information sufficient to access the database on the server via the Internet.

46. A digital medium as recited in claim 37, wherein the personalization method includes permanently modifying the digital medium.

47. A method of personalizing content recorded on a digital medium, the method comprising:
accepting log-in information from a remote user;
accepting from a user personal information on a particular human subject, including the particular name of the particular human subject;
accessing a database of content relative to each of a plurality human subjects' personal information, including the human subjects' names, the access according to the particular name, the access retrieving content relative to the particular human subject;
sending content including the retrieved content relative to the particular human subject, such that the remote user can create the digital medium that includes personalized content,
such that playback of the content of the created digital medium provides a human with a rendering of the content personalized according to the particular one of the plurality of names.

48. A method as recited in claim 47, wherein the sending is via the Internet.

49. A method as recited in claim 47, wherein the personalized content includes audio content of interest to human subjects, such that upon subsequent playback of the content of the digital medium, at least the name of the particular human subject is invoked in at least an audio rendition of the media.
